(19) United States
(12) Patent Application Publication
(10) Pub. No.: US 2013/0127369 A1
(43) Pub. Date: May 23, 2013

(54) DISPLAY CONTROL SYSTEM FOR LIGHT EMITTING DIODE (LED) LIGHTING FIXTURES

(71) Applicants: Gregory Campbell, Walpole, MA (US); Vincent Gerard D'Agostino, Walpole, MA (US)

(72) Inventors: Gregory Campbell, Walpole, MA (US); Vincent Gerard D'Agostino, Walpole, MA (US)

(73) Assignee: LUMENPULSE LIGHTING INC., Montreal (CA)

(21) Appl. No.: 13/470,747

(22) Filed: May 14, 2012

Related U.S. Application Data
(60) Provisional application No. 61/485,901, filed on May 13, 2011.

(51) Int. Cl. H05B 33/08

(52) U.S. Cl. CPC H05B 33/0842
USPC 315/292

(57) ABSTRACT

An LED lighting array control system for a lighting array including a power/control wiring system and a master controller including a memory for storing lighting programs which comprise control codes for controlling operation of the LEDs and a current program identification code including a program selection code identifying a lighting program to be executed and at least one parameter code identifying a controllable aspect of the lighting program. A user input control device with a rotatable and depressible control for selecting and generating the program selection code of the lighting program to be executed and the at least one parameter code, which may be transmitted to the fixtures through a control bus or through a powerline control system.

### RELATED APPLICATIONS

The present application claims priority to U.S. Provisional Patent Application No. 61/485,901, filed May 13, 2011, which is incorporated in its entirety herein by reference.

### FIELD OF THE INVENTION

The present invention relates to the control of lighting fixtures and, in particular, the control of light emitting diode (LED) lighting fixtures.

### BACKGROUND OF THE INVENTION

The availability of light emitting diodes (LEDs) in a range of spectral colors and at relatively high emitted power levels has made possible the construction of lighting fixtures comprising arrays of LEDs having selectable emitted light levels and color characteristics for a variety of purposes, including both functional and decorative lighting. For example, the use of arrays of LEDs having differing emission colors, such as red, blue, green, amber, cyan, royal blue, yellow, warm white and cool white and controllable emission power levels allows the construction of lighting fixtures that in themselves are capable of a variety of emitted light effects, such as selectable colors, including multiple colors, moving light effects, and time varying color and power emission levels.

Among the problems that are hindering the adoption of solid state lighting systems, however, is the control of lighting fixtures which comprise arrays of LEDs. The ability to control the light level output of LED lighting systems, that is, dimming control, is much more complex in LED lighting systems than in the case of conventional lighting systems because of the greater electrical complexity of the LED lighting fixtures.

In general, there are two primary methods for controlling lighting arrays which comprise arrays of LEDs, one being the use of dedicated control lines or buses separate from the power lines providing power to the LED lighting fixtures. While the use of separate control lines may significantly increase the costs of a lighting system and may be impractical in the case of existing installations, the use of separate control lines would necessitate the installation of new control lines into existing structures. The use of separate control lines does at least potentially allow greater lighting system control capabilities.

The most commonly used alternate fixture control system, which is often referred to as powerline communication system or powerline carrier communication system, transmits control data or commands for the lighting fixtures on a conductor that is also used for electric power transmission, such as a conventional 117 volts AC line, a 230 volts AC line conventionally used in Europe, a 100 volt AC line conventionally used in Japan or a 277 volt AC line conventionally used in certain commercial applications in the United States. There are many different ways to communicate on a powerline, but ultimately all communication is done by impressing a modulated carrier signal onto the system power conductors together with the 117 volt AC power signal and, thereafter, separating the power signal and the communication signal(s) at a receiving point. While powerline communication applications are currently available, for example, in the utility meter reading and home automation markets, for a number of reasons they are essentially nonexistent in architectural solid state lighting systems, primarily because of the greater electrical complexity of the LED lighting fixtures.

For example, two of the common industry standard methods for dimming control of lighting systems are 0-10V dimmers and the Digital Addressable Lighting Interface (DALI), both of which provide a digital control of the power output of the lighting systems. Both of these methods are effective, but require the provision of control wiring which is separate from the conventional AC power lines. The addition of 0-10V dimmers or DALI to a lighting installation thus generally requires the retrofitting of any proposed installation site with the necessary control wiring, which typically requires ripping out or removing existing wiring and the addition or installation of new control wiring. The addition of conventional dimming controls, such as the 0-10V dimmers or DALI, to a lighting installation thereby often imposes significant additional costs as well as additional time to accomplish the installation of the control wiring and associated controls.

There also exist dimming technologies used for traditional lighting sources which do not require any extra communication wire(s). While there are many dimming technologies, two of the most popular are triac and ELV dimming. Both “phase chop” the AC signal, making less AC power available for the traditional light sources, hence causing the traditional light sources to provide less illumination output. These dimming technologies have been adapted to solid state lighting fixtures; however, since they are analog in nature, they are not an ideal solution due to the strictly digital nature of LEDs. However, there are two distinct disadvantages in incorporating triac or ELV into the LED fixture. For example, triac dimming uses a conventional power distribution line together with a single or multiple lead control bus for the communication of fixture control signals or a powerline communication control system and ELV systems are not capable of providing the range of lighting control functions that are inherent in lighting fixtures and systems which comprise arrays of LEDs. In addition, there is an added cost associated with adding analog circuitry to transmit the triac or the ELV dimming signals over a power line and to convert the analog signals to digital signals suitable for controlling the LED fixtures. Further, the addition of such specific purpose circuitry commits the LED fixture manufacturer to one technology, thus limiting the ability of the manufacturer to adapt to other dimming technologies that may be required for different applications and installations.

The present invention provides a solution to these as well as other related problems associated with the prior art.

### SUMMARY OF THE INVENTION

The present invention is directed to a lighting array control system for a lighting array including a plurality of light emitting diode (LED) lighting fixtures connected with a power/control wiring system, each LED lighting fixture including a plurality of LEDs selected from at least one of a plurality of LED emission colors and the light array control system including at least one master controller. According to the present invention, each master controller includes a memory for storing at least one lighting program wherein each lighting program includes at least one control code for controlling operation of the LEDs of a lighting fixture, and a current program identification code including a program selection code identifying a lighting program to be executed by the lighting array control system and at least one parameter code identifying a controllable aspect of the lighting program to be executed. A user input control device selects and generates the program selection code of the lighting program to be executed and the at least one parameter code of the lighting program to be executed and a processor controlled by the current program identification code and a corresponding lighting program for reading from memory and generating control codes corresponding to the lighting program to be executed. A control bus interface is provided for transmitting the control codes corresponding to the lighting program to be executed onto the power/control wiring system.

According to further aspects of the present invention, the user input control device includes a rotatable and depressible control wherein each depression of the control increments a first cyclic counter to generate a repeating sequence of program selection codes, a depression of the control for a predetermined period of time increments a second cyclic counter to generate to repeating sequence of first parameter codes corresponding to and defining a first aspect of an execution of a current lighting program, and a rotation of the control generates a second parameter code corresponding to and defining a second aspect of an execution of a current lighting program.

In present embodiments of the invention, the lighting programs include at least one of a fixed color program, a color fade program, a chasing fade program, a random fade program, a white light program, a white chase program, a white sparkle program and an off mode, and the LEDs of a lighting fixture are selected as a combination of at least one of red, blue, green, amber, cyan, royal blue, yellow, warm white and cool white LEDs.

In still further aspects of the present invention, the LEDs of the lighting fixture are organized into a plurality of groups of LEDs and the LEDs in each group of LEDs are organized into a plurality of channels of LEDs, each channel is separately controllable by a lighting program and, in certain embodiments of the present invention, each channel of LEDs corresponds to and includes LEDs selected from one color of a plurality of colors of LEDs. For example, the color of the LEDs of a channel are selected from one of red, blue, green, amber, cyan, royal blue, yellow, warm white and cool white.

### BRIEF DESCRIPTION OF THE DRAWINGS

The invention will now be described, by way of example, with reference to the accompanying drawings in which:

FIGS. 1A, 1B and 1C are block diagrams of control systems for LED lighting fixtures;

FIG. 2 is a block diagram of an exemplary LED lighting fixture;

FIG. 3A is a block diagram of a master controller for LED lighting fixtures; and,

FIG. 3B is an isometric view of a master controller for LED lighting fixtures.

FIG. 4 is a schematic illustration of an exemplary controller for a LED lighting fixture.

FIG. 5 is a flowchart of a method for adjusting parameters for a lighting program, according to an illustrative embodiment.

FIG. 6 is a flowchart of a method for adjusting parameters for a lighting program, according to an illustrative embodiment.

### DETAILED DESCRIPTION OF THE INVENTION

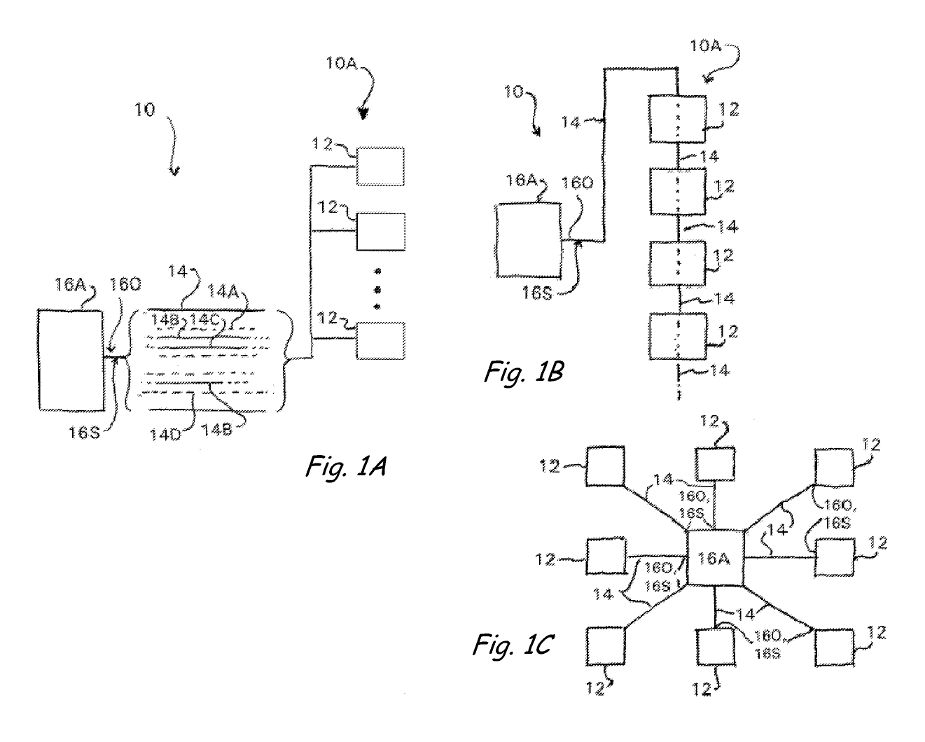

Referring to FIGS. 1A, 1B and 1C, therein are shown block diagrams of an exemplary lighting array control system 10 for a lighting array 10A including a plurality of LED lighting fixtures 12 powered from and controlled through a power/control wiring system 14 wherein the power/control wiring system 14 may be implemented as, for example, a conventional power distribution system 14A having a conventional power distribution line 14B together with a single or multiple lead control bus 14C for the communication of the fixture control signals or a powerline communication control system 14D wherein the fixture control signals are communicated through the power distribution line 14B. In the lighting arrays 10A illustrated in FIGS. 1A, 1B and 1C, the power distribution system 14A may comprise, for example, of a 117 volt AC network, which is commonly employed in the United States, or functionally equivalent system, such as a 230 volts AC line commonly employed in Europe, a 100 volt AC line commonly employed in Japan or a 277 volt AC line commonly employed in certain commercial applications in the United States. In yet other embodiments, the light array control system 10 will provide power to the lighting fixtures 12 through a power distribution line 14B, but the control bus 14C or the transmission of fixture control signals to the lighting fixtures 12 via a powerline communication control system 14D may be replace by, for example, a wireless (WII) type communication system.

As illustrated in FIG. 1A, the lighting fixtures 12 may be connected directly in parallel with the power/control wiring system 14, or sequentially along the power/control wiring system 14, as illustrated in FIG. 1B, or in parallel or sequentially along a radiating star pattern of the power/control wiring system 14 branches, as illustrated in FIG. 1C, or any combination thereof.

As illustrated, a lighting array control system 10A includes a master controller 16A having a control output 160 connected to the power/control wiring system 14, that is, either to control bus 14C in a lighting array control system 10A having the control bus 14C separate from the power distribution line 14B or to power distribution line 14B in a powerline communication system, to transmit lighting program control signals 16B to the lighting fixtures 12. As will be described in a following detailed description of a master controller 16A, the master controller 16A converts the user inputs, selecting and determining the characteristics of an illumination program to be performed by LED lighting fixtures 12, into corresponding lighting program control signals 16S, and imposes the lighting program control signals 16S onto the power/wiring control system 14, whereby the program control signals 16S are the transmitted to each one of the LED lighting fixtures 12 in order to control the light emissions of each of the lighting fixtures 12.

Briefly considering program control signals 16S, the lighting program control signals 16S may be, for example, in the form of frequency shift keyed (FSK) signals or differential frequency (DFSK) or differential phase shift keyed signals (DPSK). As will be described in the following detailed description of a master controller 16A, the command code format for the lighting program control signals 16S may be, for example, that of a commercially available controller format, a version thereof modified for the specific needs of the powerline communication control system 10 or a command code format specifically designed for the powerline communication control system 16.

In an embodiment of the present invention, however, the program control signals 16S are in accordance with and meet the requirements and specifications of industry standard USITT DMX 512-A Asynchronous Serial Digital Data Transmission Standard for Controlling Lighting Equipment and Accessories, which is well understood by those of ordinary skill in the relevant art and is commonly used for the control of lighting systems.

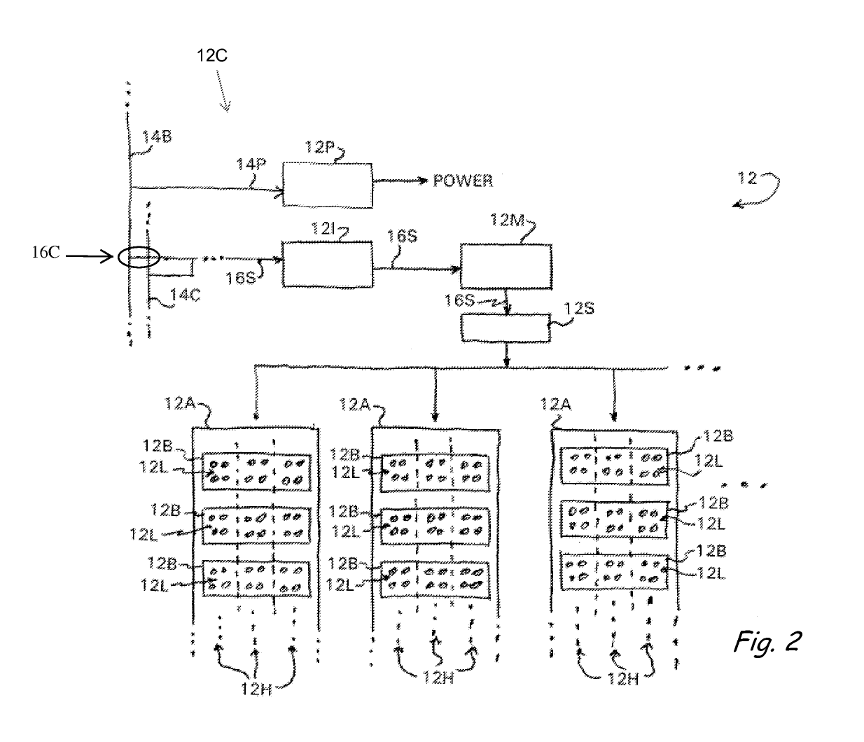

As illustrated in FIG. 2, and as will be described in further detail in a following discussion, each of the lighting fixtures 12, in turn, has a fixture control unit 12C having a control input 16C connected either with the control bus 14C of the lighting array control system 10A having the control bus 14C separate from the power distribution line 14B or with the power distribution line 14B in the powerline communication system to receive the lighting program control signals 16S, and the input connected with the power distribution line 14B.

As illustrated in FIG. 2, the fixture control unit 12C of the lighting fixture 12 includes a power unit 12P connected with the power distribution line 14B to receive the power signal 14P from the power/control wiring system 14 and to provide power to one or more of the LED arrays 12A. The fixture control unit 12C further includes a control interface unit 121 that may be connected with the control bus 14C, in the lighting array control system 10 having the control bus 14C separate from the power distribution line 14B, or with the power distribution line 14B in the lighting array control system 10 employing a powerline communication control system 14D. In the case of a lighting array control system 10 having the control bus 14C separate from the power distribution line 14B, the control interface unit 121 passes the received lighting program control signals 16S to a processor 12M, or equivalent control circuitry, which decodes the lighting program control signals 16S and then passes the corresponding control signals to the LED arrays 12A through, for example, an array interface 12S. In the case of a lighting array control system 10 employing the powerline communication control system 14D, the control interface unit 121 separates the lighting program control signals 16S from the power signal 14P before decoding the lighting program control signals 16S and passing the decoded lighting program control signals 16S to the processor 12M and the array interface 12S.

As further illustrated in FIG. 2, each of the lighting fixtures 12 includes one or more LED arrays 12A wherein each of the LED arrays 12A typically comprises a plurality of individual LEDs 12L which, in turn, may be organized into further control sub-groups of LEDs 12L, as discussed below. The LED arrays 12A are powered by the power input 16P and the light emissions of the LED arrays 12A are controlled by the fixture control unit 12C according to the commands of the programs control signals 16S.

In the exemplary embodiment of the lighting fixture 12 illustrated in FIG. 2, the LEDs 12L of the lighting fixture 12 may comprise various combinations of LEDs 12L selected from red, blue, green, amber, cyan, royal blue, yellow, warm white and cool white LEDs, as desired or necessary, in order to implement the desired lighting programs for each LED lighting fixture 12. In certain embodiments of the lighting fixture 12, and for example, the LEDs 12L may be organized in a generally linear array to provide the lighting fixture 12 with a generally linear light emission pattern.

In one such linear lighting fixture 12, for example, the LEDs 12L may be arranged on three circuit boards 12B in which each circuit board 12B may include, 36 LEDs 12L for example, having a total of 108 LEDs 12L. The 36 LEDs 12L on each circuit board 12B may, in turn and for example, be organized as individually controllable channels 12H. In an embodiment having three channels 12H, for example, each channel 12H would therefore include 12 LEDs 12L and wherein each given channel 12H contains LEDs 12L of the same type of LEDs, such as red, blue, green, amber, cyan, royal blue, yellow, warm white or cool white LEDs 12L. Other embodiments, however, may implement fewer or more channels 12H, with at least some embodiments implementing the capability of controlling, for example, 9 channels 12H.

The LEDs 12L of each channel 12H may, in turn, be physically organized as a group, such as in lines, blocks or clusters, or may be distributed in the array or in virtually any other desired scheme so as to provide the desired light emission pattern. In other embodiments, and again by way of example, the LEDs 12L may be organized as a generally polyangular array, such as a hexagonal array, to provide a spot-emission pattern or floodlight emission pattern. In such embodiments, the LEDs 12L may be organized within the array according to any desired pattern as required or desirable to achieve the desired light emission pattern. For example, the LEDs 12L of the lighting fixture 12 may be arranged as three channels 12H and each one of the three channels 12H may have, for example, a diamond shape rather than a rectangular shape. Again, the LEDs 12L of each channel 12H may, in turn, be physically organized as a group, such as in lines, blocks or clusters, or may be distributed in the array in any other scheme so as to provide the desired light emission pattern.

In this regard, it is to be understood that the physical arrangement or organization of the LEDs 12L, in the LED array 12A of the lighting fixture 12, and the organization of the LEDs 12L, of the LED array 12A, are essentially mutually independent of each other except that the total number of LEDs 12L, in the physical organization of the LED array 12A, is equal to the total number of LEDs 12L in the channels 12H of the LED array 12A. For example, the LED array 12A may contain 2 red, 2 blue, 2 green, 2 amber, 2 warm white and 2 cool white LEDs 12L for a total of 12 LEDs 12L organized into 6 channels 12H, that is, 1 red channel comprising the 2 red LEDs, 1 blue channel comprising the 2 blue LEDs, 1 green channel comprising the 2 green LEDs, 1 amber channel comprising the 2 amber LEDs, 1 warm white channel comprising the 2 warm white LEDs and 1 cool white channel comprising the 2 cool white LEDs, with the 12 LEDs 12L being physically arranged as two rows of six LEDs 12L with each row being 2 LEDs 12L across, or as one row of 12 LEDs 12L, or in a diamond pattern, etc.

Another LED array 12A may also contain 12 LEDs 12L physically arranged in the same mechanical organization as those of the first example, and organized as 3 channels 12H with each channel 12H containing 4 LEDs 12L, such as, and for example, 4 red LEDs 12L, 4 amber LEDs 12L and 4 blue LEDs 12L.

In accordance with the organization of LEDs 12L in the LED lighting fixture 12 according to the present invention, and as will be discussed in further detail below, the lighting program control signals 16S, generated by a master controller 16A, may be specifically addressed to the individual LED lighting fixtures 12, to groups of the lighting fixtures 12, or to the circuit boards 12B or the channels 12H within each lighting fixture, thereby allowing individualized control of the lighting fixtures 12 or the groups of lighting fixtures 12, or the circuit boards 12B or the channels 12H or the groups of the circuit boards 12B or the channels 12H in the lighting fixture 12 or the groups of lighting fixtures 12, thereby allowing detailed definition and control of an illumination program to be performed by a lighting array 10. In addition, and alternately, the lighting program control signals 16S may be generated and transmitted by the master controller 16A as broadcast commands to the lighting fixtures 12 thereby to control all or selected groups of the lighting fixtures 12 or all of or groups of the circuit boards 12B or the channels 12H within one or more of the lighting fixtures 12, thereby allowing various combinations of the lighting fixtures groups of the circuit boards 12B or channels 12H within one or more lighting fixtures 12 to be controlled concurrently and in parallel with one another.

As discussed herein above, the lighting program control signals 16S are generated and transmitted through the control bus 14C or the powerline communication control system 14D to the lighting fixture 12 or fixtures 12 of the lighting array control system 10 (of FIG. 1) by one of one or more master controllers 16A. In an embodiment of the lighting array control system 10 of the present invention, the master controller 16A may generate and transmit lighting program control signals 16S for a number of lighting programs, including, for example:
(A) a fixed color program comprising the emission of a fixed, individual color, such as warm or cool white, red, blue, green, amber, cyan, royal blue, or yellow light at a selected emission power or intensity level, wherein the selection of the emitted light power or the intensity may be available only for white light emission;
(B) a color fade program wherein the color of the light emitted by the fixture cycles repeatedly through a selected range of colors;
(C) a “fade” program in which one or more colors repeatedly cycle through a sequence of one or more of the lighting fixtures 12;
(D) a “random fade” program in which one or more colors appear in a random sequence across or in one or more of the lighting fixtures 12 with lower intensity transitions between colors at programmably selectable rates;
(E) a “white light” program in which one or more of the lighting fixtures 12 emits white light at a selectable intensity level;
(F) a “white chase” program as in the “chasing fade” program except that the emitted light is all white of programmably selectable intensity levels;
(G) a “white sparkle” program in which white light is emitted from apparently random segments of one or more of the lighting fixtures 12 at programmably selectable intensities and at programmably selectable rates; and,
(H) an “off” mode program in which all of the LEDs 12L of the lighting fixture 12 or lighting fixtures 12 are turned off, that is, and thus do not emit light.

It will be understood, however, that other lighting programs may be created and implemented as available within the capabilities of, for example, USITT DMX 512-A Asynchronous Serial Digital Data Transmission Standard for Controlling Lighting Equipment and Accessories or any other selected or created lighting control code format implemented for use in the lighting array control system 10 according to the teachings and disclosures of the present invention.

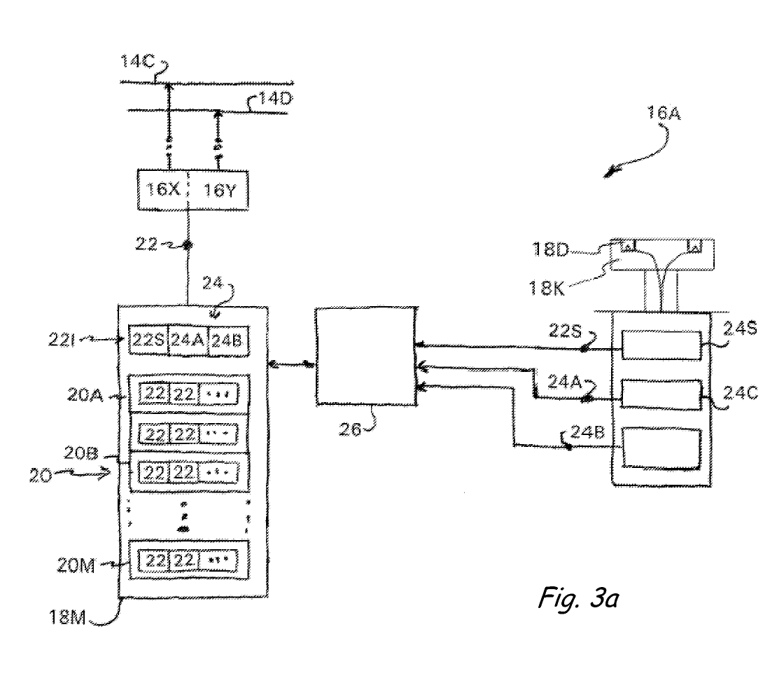

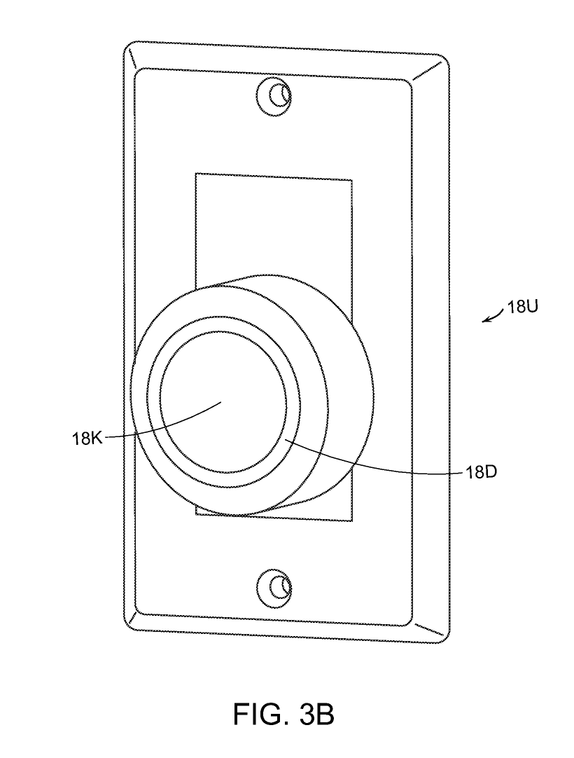

Now referring to FIG. 3A, a diagrammatic block diagram of the master controller 16A, for the lighting array control system 10 of FIG. 1, is shown therein. As illustrated, the master controller 16A may include a memory 18M, such as an EEPROM (Electronically Erasable Programmable Read Only Memory), for storing desired lighting programs 20 implemented in the lighting array control system 10. Each lighting program 20 comprises a sequence of control codes 22 for controlling the operations of the lighting fixtures 12 of the LED lighting array 10A of FIG. 1. In a present embodiment of the lighting array control system 10, and as discussed above, the lighting programs 20 may include, for example, one or more of: a fixed color program(s) 20A, a color fade program(s) 20B, a “chasing fade” program(s) 20C, a “random fade” program(s) 20D, a “white light” program(s) 20E, a “white chase” program(s) 20F, a “white sparkle” program(s) 20G and an “off” mode program(s) 20H, as described above, or any other lighting program(s) 20, incorporating one or more features of these programs, or which may be written within the capabilities of the control code system selected for use in the lighting array control system 10 is also described above, and for example, in an embodiment of the lighting array control system 10 and the master controller 16A, the control codes 22 comprise the appropriate control codes defined in USITT DMX 512-A Asynchronous Serial Digital Data Transmission Standard for Controlling Lighting Equipment and Accessories.

In this regard, it must also be noted that in addition to storing the lighting programs 20, the memory 18M, or possibly a separate but generally equivalent memory, may be used to store a current program identifier code 221 which defines the lighting program 20 currently being executed by the lighting array control system 10 and, as described below, certain parameters which define corresponding selectable and controllable aspects of the light program 20 being currently executed. In addition to selecting the lighting program 20 whose control codes 22 are to be read from the memory 18M for control of the lighting fixtures 12, the current program identifier code 221 will remain resident in the memory 18M, or any other memory that is used for that purpose, when the lighting array control system 10 and thus the LED lighting array 10A is placed in the “off” state or “off” mode program to thereby be immediately available upon reactivation of the lighting array control system 10.

As also illustrated in FIG. 3A, the master controller 16A further includes one or more user control input devices 18U which are used by a user to generate the current program identifier code 221 which, as described, identifies and selects the lighting program 20 to be executed by the master controller 16A and certain parameters of the selected lighting program 20, such as light emission color, light emission intensity, and rate or period of the light emission transition effects, such as rate of movement along a fixture 12 of fading from one color to a next color. In an embodiment of the master controller 16A, the program identifier code 221 may comprise a program select code 22S identifying the lighting program 22 to be executed and one or more parameter codes 24 which identify the parameters of the selected lighting program, such as light intensity, light color and rate of change of light effects.

In an embodiment of the user control input device 18U, as illustrated in isometric view in FIG. 3B, a user control input device 18U has general appearance of and operates in a manner generally similar to a conventional wall mounted lighting dimmer unit, thereby allowing a user control input device 18U to be mounted in a conventional manner and to be operated in a manner generally familiar to many users.

As such, and as illustrated, the primary and effectively sole user control input to the user control input device 18U comprises a rotatable/depressible program select knob 18K. In a present embodiment of the master controller 16A, rotation of the rotatable and depressible program select knob 18K generates program select codes 22S which identifies and determines which of the lighting programs 20 implemented in the master controller 16A and the lighting array control system 10 is desired to be executed while depression of the program select knob 18K generates various parameter codes 24 of the selected lighting programs 20.

As will be well understood by those of ordinary skill in the arts, the program select codes 22S may be generated by, for example, depression of the program select knob 18K wherein each depression of the program select knob 18K generates an output pulse which increments a cyclic counter residing, for example, in the user control input device 18U and wherein the count output of the user control input device 18U comprises the current program selection code 22S. A user may therefore rotate through the available lighting programs 20, implemented in the master controller 16A, by repeated depression of the program select knob 18K thereby to select the desired lighting program 20 to be implemented.

The depression of the program select knob 18K may also be used to generate a first parameter code 24A by causing a parameter counter 24C to increment at a predetermined rate, such as once every three seconds, during those periods in which the program select knob 18K is depressed, with the parameter code 24A output of the parameter counter 24C output controlling, for example, the number or the resolution of the fixtures 12 to be active and controlled by the master controller 16A during execution of the currently selected lighting program 20, such as a single fixture, 2 fixtures, 4 fixtures, and so on.

Rotation of the program select knob 18K, in turn, may be used to generate a second parameter code 24B which may be used, for example, to control the light emission intensity, the color or the rate of change or transition, of the colors during a given lighting program 20. The parameter code 24B may, for example, control emitted light intensity during execution of the white light program 20E, the color of emitted light during execution of the fixed color program 20A, or the speed or rate of change of lighting emission effects during, for example, the color fade program 20B, the chasing fade program 20C, the random fade program 200, the white chase program 20F and the white sparkle program 20G. As will be well understood by those of ordinary skill in the arts, the parameter codes 24B may be generated upon rotation of the program select knob 18K by, for example, the sequential actuation or opening and closing of rotation shaft mounted switches as the program select knob 18K rotates, by an encoding disk mounted on a rotatable shaft of the program select knob 18K, by a rotary encoder to a rotating shaft of the program select knob 18K, and so on.

As further indicated in FIG. 3A, the master controller 16A will typically further include a processor 26 that is responsive to the program selection code 22B and parameter codes 24B of the current program identifier code 221 to read the appropriate corresponding control codes 22 of the lighting program(s) 20 from the master controller memory and to transmit the control codes 22 to the lighting fixtures 12 through the control bus 14C or through the powerline communication control system 14D. In the case of the lighting array control system 10 in which the power and the control lines are separate, the master controller 16A will correspondingly include a control bus interface 16X which interfaces the output of the control codes 22 of the master controller 16A with the control bus 14C. In lighting array control systems 10 employing the powerline communication control system 14D, the master controller 16A will include a control bus interface 16Y which is connected from and to the power distribution line 14B of the powerline communication control system 14D for transmitting the control codes 22 to the lighting fixtures 12 through the power distribution line 14B of the powerline communication control system 14D.

Lastly, it will be understood by those of ordinary skill in the relevant art that the master controller 16A, like the fixture control units 12C, will include power supplies connected with the power distribution line 14B of the conventional power distribution system 14A or the powerline communication control system 14D, depending on the specific implementation of the LED lighting array 10A and the lighting array control system 10.

A novel aspect of the user control input device 18U is that the front face of the program select knob 18K contains a circular LED display 18D which is coupled, in parallel, to the master controller 16A for simulating the illumination effected be achieved by the illumination system. That is, as the user programs the illumination system as described above, the illumination control commands, which are being sent to the individual LEDs, are also sent to the circular LED display 18D so that the user can view and preview the illumination effect to be achieved by the illumination system and suitably modify the same, as necessary, to suit the user's need or desire. That is, the user can instantaneously preview the illumination to be achieved by the illumination system, by viewing the illumination of the circular LED display 18D, and accordingly modify or alter the same.

For example, the user can first select, via actuation of the program select knob 18K, one of a fixed color program(s) 20A, a color fade program(s) 20B, a “chasing fade” program(s) 20C, a “random fade” program(s) 20D, a “white light” Program(s) 20E, a “white chase” program(s) 20F, a “white sparkle” program(s) 20G and an “oft” mode program(s) 20H. Next, the user can modify, via actuation of the program select knob 18K, a shade of the selected color, an increase or a decrease the intensity of the selected color or illumination, an increase or a decrease the speed at which the illumination system cycles through different illumination effects or different programs, etc., all via suitable actuation of the program select knob 18K.

In the event that the user does not activate the user control input device 18U for a sufficient duration of time, e.g., between 15 seconds and 2 minutes, more preferably about 30 second, then the circular LED display 18D becomes dormant and inactive since the supply of power thereto is discontinued until the user control input device 18U is again actuated by the user. Accordingly, the circular LED display 18D provides the user with a visual display which assists the user with selection and programming of the desired illumination.

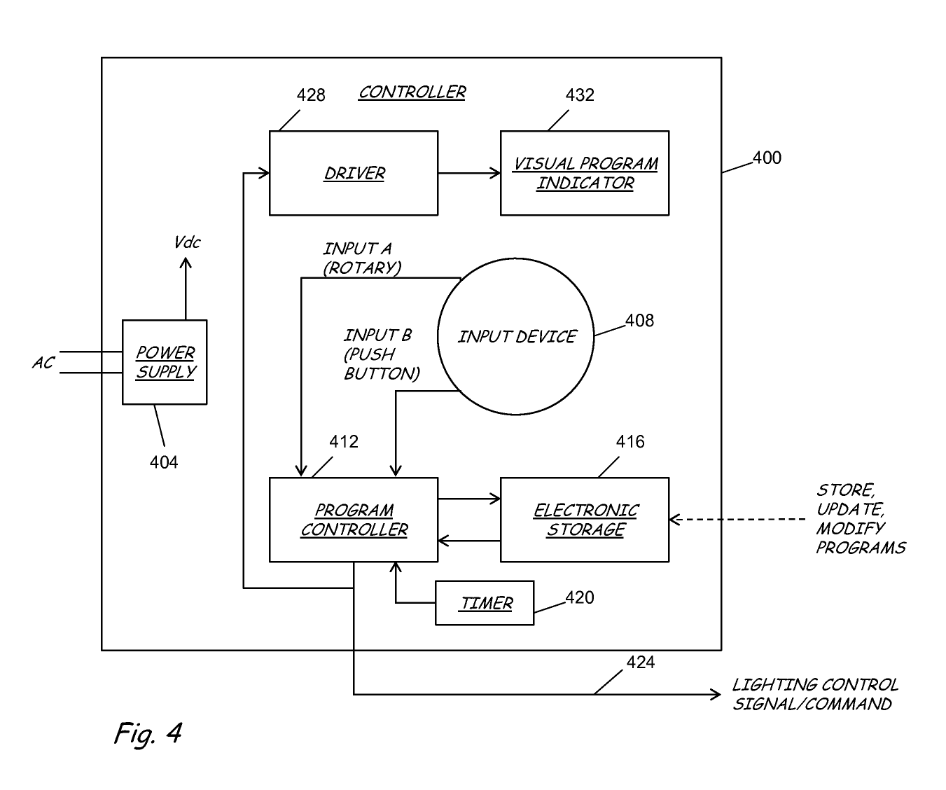

FIG. 4 is a schematic illustration of an exemplary controller 400 for a LED lighting fixture. The controller 400 includes a power supply 404 that receives AC power to operate the controller 400 and a light fixture (not shown) coupled to the output 424 of the controller 400. The output 424 of the controller 400 is provided to the light fixture controller (e.g., lightlighting array control system 10 of FIG. 1A). The power supply 404 outputs a DC voltage (Vdc) to power the controller 400. An output 424 of the controller 400 is controlled in response to an input device 408 associated with the controller. In this embodiment, the input device 408 is a rotatable/depressible device that has a rotary input (Input A) and a push button/depressible input (Input B). The input device 408 provides signals to a program controller 412 to vary parameters of a lighting program (e.g., lighting program 20 of FIG. 3A).

The program controller 412 is used to both create programs (e.g., programs 20 of FIG. 3A) and to select programs for the lighting fixture to perform. The programs include one or more program select codes (e.g., program select codes 22S of FIG. 3A). The controller 400 includes electronic storage (e.g., memory) for storing, updating, or otherwise modifying programs based on, for example, user operation of the input device 408. The controller 400 also includes a timer 420 used in evaluating temporal parameters (e.g., a timeout, duration of time the push button (Input B) is depressed) associated with the user operating the input device 408. The program controller 412 is coupled to a driver 428.

The driver 428 outputs commands to a visual program indicator 432 in response to programs output by the program controller 412. The visual program indicator can be, for example, a portion of the rotary knob of the input device 408 that includes one or more LEDs. The driver 428 can provide commands to the visual program indicator to illuminate the LEDs. The LEDs can be commanded to illuminate in a manner that matches the illumination the output 424 would generate in the corresponding light fixture. For example, the visual program indicator can perform a random fade program to illustrate the performance to a user prior to the program being performed by the lighting fixture. In this manner, a user can preview a program before deciding to send the program to the light fixture to be performed. For example, a user could view one or more programs via the visual program indicator before commanding the light fixture to perform a specific program.

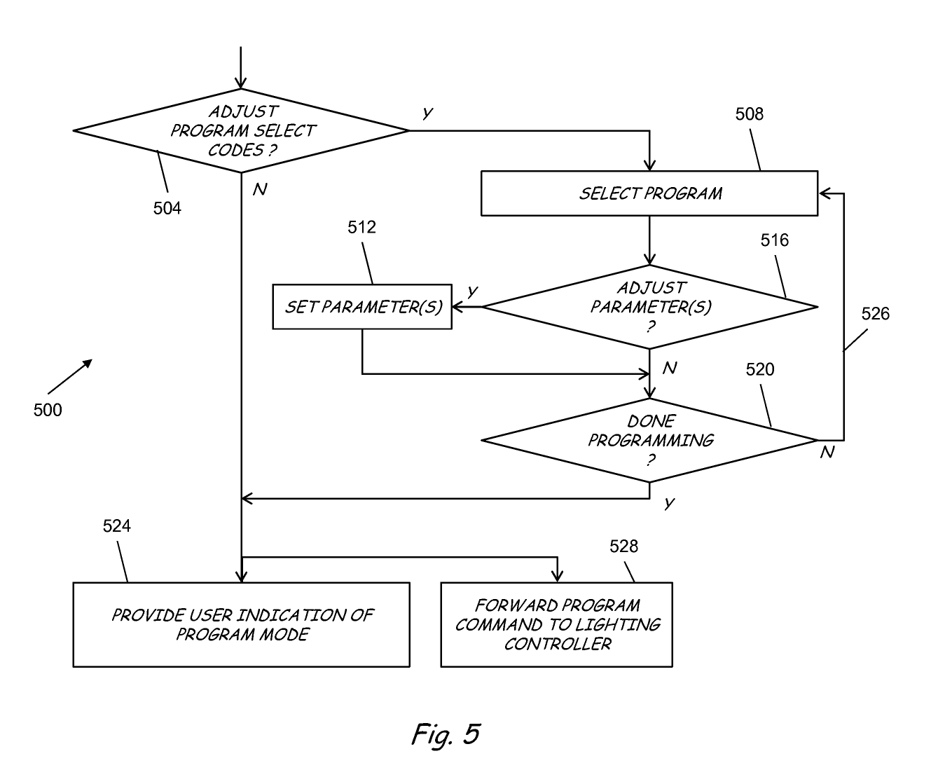

FIG. 5 is a flowchart 500 of a method for adjusting parameters for a lighting program, according to an illustrative embodiment. A user may, for example, enter a command to a light fixture controller (e.g., controller 400 of FIG. 4) to begin a process of adjusting, creating, updating or otherwise modifying lighting programs (e.g., programs 20 of FIG. 3A). A user could for example, double click the push button interface of an input device (i.e., depress the Input B of the input device 408 of FIG. 4 twice in rapid succession) to command the controller to initiate the process. If a user commands the controller to adjust program select codes (step 504), user then selects a program (step 508). A user can do this by, for example, rotating a rotary input of the input device. Rotation of the rotary input cycles through multiple stored programs. Each program can be momentarily displayed on a visual program indicator (e.g., visual program indicator 432 of FIG. 4) to serve as a cue for the user in deciding which program to select. When the user depresses the push button interface, the program is selected.

The user can then choose to adjust specific parameters of the selected program (step 516) by, for example, again depressing the push button interface twice in rapid succession. The user then sets parameters for the selected program (step 512). For example, the user can rotate the rotary knob of the input device to change the speed at which a fade program cycles through one or more colors associated with the light fixture and its fade program. The method also includes completing the programming (step 520). One skilled in the art will recognize and appreciate that the different functionality (e.g., push button, rotary knob) provided by an input device can be used to adjust multiple parameters and/or multiple programs (step 526) by varying the input provided to the device (e.g., depressing the button, rotating the knob, durations of time for depressing and rotating, and combinations thereof). A user can specify that the programming is complete but, for example, depressing the push button interface three times in rapid succession.

After the programming is completed, the adjusted program is provided to the user (step 524). The adjusted program can be provided to the user in a visual manner (e.g., displayed on the visual program indicator 432 of FIG. 4). The adjusted program is then forwarded to the lighting controller (step 528) to be performed by the light fixture. Transitioning from step 524 to step 528 can be done, for example, automatically once the user has finished programming or in response to the user inputting a known command (e.g., depress push button for 10 seconds).

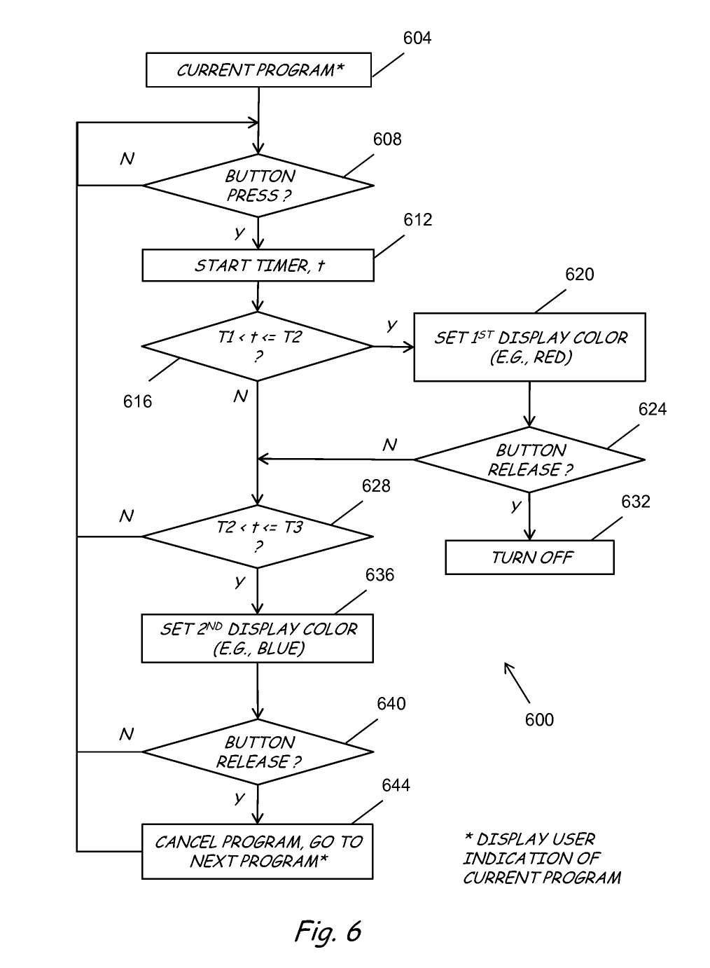

FIG. 6 is a flowchart 600 of a method for adjusting parameters for a lighting program, according to an illustrative embodiment. Once a program has been selected (step 604) for the purpose of adjusting parameters associated with the program, the lighting controller (e.g., program controller 412 of FIG. 4) monitors the input device (e.g., input device 408 of FIG. 4) until the controller determines that the button has been depressed (step 608). After the controller determines the button has been depressed, the controller starts a timer (step 612). The controller monitors the timer (step 616). When the timer satisfies a predetermined condition (e.g., when the time since initiation of the timer reaches T1<t<=T2), the controller sets a first display color. If the user releases the button, the first display color has been selected for the program and the controller turns off the programming mode (step 632). If, however, the user has not released the button, the controller continues to monitor the timer until a second predetermined condition is satisfied (when the time since initiation of the timer reaches T2<t<=T3). When the condition is satisfied, the controller sets a second display color (step 636). If the user releases the button, the second display color has been selected for the program and the controller turns off the programming mode (step 632).

Various programs and parameters may be implemented in alternate embodiments. Table 1 includes an exemplary set of programs that may be implemented, a description of the programs, and exemplary ways in which the parameters of the programs can be selected. Additionally, the input device control will perform as follows: Tap: push knob for less than 2 seconds to change program; Rotate: turn knob right and left, right to increase speed, left to slow speed; Push-Turn: push knob in and rotate right to increase resolution, push knob in and turn left to decrease resolution, push knob in and turn right to switch between color channels in a program; Off: push and hold knob for 4 seconds (knob will turn red, release while red); Disable show: push and hold knob for 8 seconds (knob will turn blue, release while blue); Enable: push and hold knob for 12 seconds (knob will turn green, release while green), function will enable all programs.

TABLE 1

| Program | Description | Program Selection |
|---|---|---|
| RGB Scenes: | | |
| Selectable Color | Displays a single, static color across | Rotate knob to select color |
| | all fixtures | |
| Dynamic Color | Cycles automatically through colors | Rotate knob to select transition |
| | across all fixtures | speed |
| Rainbow | Displays a rainbow sequence of | Rotate knob to select chase speed |
| | color moving linearly across all | Push-turn right/left to change |
| | fixtures | resolution (1, 2, 4, 8 foot segments) |
| White Scenes: | | |
| White Dim | Displays standard dimming | Rotate knob to set intensity |
| | capabilities | |
| White Comet | White intensity moves across | Rotate knob to select chase speed |
| | fixtures in a linear fashion becoming | Push-turn right/left to change |
| | progressively dimmer; fixtures | resolution (1, 2, 4, 8 foot segments) |
| | without comet are fully dim | |
| Random White Sparkle | Displays random white bursts of | Rotate knob to select transition |
| | various intensities on each fixture | speed |
| | | Push-turn right/left to change |
| | | between snap and fade transition |

It will be recognized with regard to the above descriptions of possible implementations of the powerline communication control system of the present invention that certain changes may be made in the above described improved powerline communication control system, without departing from the spirit and scope of the invention herein involved. For example, while an embodiment of the invention has been described and discussed in detail herein above, it must be recognized that other features and/or combinations of features described herein above may comprise other embodiments not specifically described above. It is therefore intended that all of the subject matter of the above description or shown in the accompanying drawings shall be interpreted merely as examples illustrating the inventive concept herein and shall not be construed as limiting the invention.

Wherefore, I/we claim:

1. A lighting array control system for a lighting array including a plurality of light emitting diode (LED) lighting fixtures connected with a power/control wiring system, each LED lighting fixture including a plurality of LEDs selected from at least one of a plurality of LED emission colors and the light array control system including at least one master controller, each master controller comprising:
a memory for storing
at least one lighting program wherein each lighting program includes at least one control code for controlling operation of the LEDs of a lighting fixture, and
a current program identification code including a program selection code identifying a lighting program to be executed by the lighting array control system and at least one parameter code identifying a controllable aspect of the lighting program to be executed,
a user input control device for selecting and generating the program selection code of the lighting program to be executed and the at least one parameter code of the lighting program to be executed,
a processor controlled by the current program identification code and a corresponding lighting program for reading from memory and generating control codes corresponding to the lighting program to be executed, and
a control bus interface for transmitting the control codes corresponding to the lighting program to be executed onto the power/control wiring system.

2. The lighting array control system of claim 1, wherein:
the user input control device includes a rotatable and depressible control wherein
each depression of the control increments a first cyclic counter to generate a repeating sequence of program selection codes,
a depression of the control for a predetermined period of time increments a second cyclic counter to generate to repeating sequence of first parameter codes corresponding to and defining a first aspect of an execution of a current lighting program, and
a rotation of the control generates a second parameter code corresponding to and defining a second aspect of an execution of a current lighting program.

3. The lighting array control system of claim 1, wherein the lighting programs include at least one of a fixed color program, a color fade program, a chasing fade program, a random fade program, a white light program, a white chase program, a white sparkle program and an off mode program.

4. The lighting array control system of claim 1, wherein the LEDs of the lighting fixture are selected as a combination of at least one of red, blue, green, amber, cyan, royal blue, yellow, warm white and cool white LEDs.

5. The lighting array control system of claim 1, wherein the LEDs of the lighting fixture are organized into a plurality of groups of LEDs, the LEDs, in each group of LEDs, are organized into a plurality of channels of LEDs, and each channel of LEDs is separately controllable by the lighting program.

6. The lighting array control system of claim 5, wherein each channel of LEDs corresponds to and includes LEDs selected from one color of a plurality of colors of LEDs.

7. The lighting array control system of claim 6, wherein the color of the LEDs of a channel are selected from one of red, blue, green, amber, cyan, royal blue, yellow, warm white and cool white.

8. The lighting array control system of claim 2, wherein the user control input device includes an LED display which is coupled, in parallel, to the master controller 16A for simulating the illumination effected be achieved by the illumination system for previewing by the user.
